(19) United States
(12) Patent Application Publication
(10) Pub. No.: US 2023/0398498 A1
(43) Pub. Date: Dec. 14, 2023

(54) SYSTEMS, METHODS, AND DEVICES FOR OPTIMIZATION OF ULTRA FILTRATION MEMBRANE PERFORMANCE FOR WATER TREATMENT USING ARTIFICIAL INTELLIGENCE AND OPTIMIZATION ALGORITHMS

(71) Applicant: Yokogawa Electric Corporation, Tokyo (JP)

(72) Inventors: Mahdi FARAMARZI, Bedok (SG); Gokula Krishnan SIVAPRAKASAM, Bedok (SG); Kaushik GHOSH, Bedok (SG); Yasuhiro MATSUI, Bedok (SG)

(21) Appl. No.: 17/749,814

(22) Filed: May 20, 2022

(51) Int. Cl. B01D 65/02; B01D 61/14

(52) U.S. Cl. CPC B01D 65/02; B01D 2321/40; B01D 2321/16; B01D 61/145

(57) ABSTRACT

A method of implementing membrane cleaning is provided. The method includes accessing a membrane resistance record, where the membrane resistance record includes a plurality of membrane resistance curves, each of the plurality of membrane resistance curves includes a curve profile after a cleaning. The method further includes performing a first cleaning, determining a first membrane resistance after the first cleaning, determining a current position on the curve profile based on the first membrane resistance and a time period from a previous cleaning, and performing a second cleaning. The second cleaning may include a recovery cleaning when the current position on the curve profile exceeds a predetermined range, and a maintenance cleaning when the current position on the curve profile is within the predetermined range.

### FIELD OF TECHNOLOGY

The following relates to processing plants including equipment such as filtration membranes, and more specifically, determining a cleaning schedule that reduces overall cost of operation and increases the lifespan of the filtration membranes.

### BACKGROUND

In some environments, access to a suitable supply of natural water sources may be limited. Improving the efficiency of wastewater treatment plants may support water recovery, energy savings (low carbon footprint), and a reduction in costs. Although some processing plants may incorporate filtration membranes in association with water treatment, techniques for improving process control associated with the filtration membranes are desired.

### SUMMARY

The described techniques relate to improved methods, systems, devices, and apparatuses that support optimization of ultra filtration membrane performance.

A method of implementing membrane cleaning includes: accessing a membrane resistance record, wherein the membrane resistance record includes a plurality of membrane resistance curves, each of the plurality of membrane resistance curves includes a curve profile after a cleaning; performing a first cleaning; determining a first membrane resistance after the first cleaning; determining a current position on the curve profile based on the first membrane resistance and a time period from a previous cleaning; and performing a second cleaning. In some aspects, the second cleaning includes a recovery cleaning when the current position on the curve profile exceeds a predetermined range, and a maintenance cleaning when the current position on the curve profile is within the predetermined range.

Any of the aspects herein, wherein determining the first membrane resistance after the first cleaning is based on first data associated with the first cleaning, wherein the first data includes information associated with at least one of: a membrane resistance before the first cleaning, chemical concentrations associated with the first cleaning, flux and total permeate volume associated with the first cleaning (i.e., flux and total permeate volume during the filtration phase before the first cleaning).

Any of the aspects herein, wherein the predetermined range is determined based on at least one of transmembrane pressure (TMP) asserted on a membrane and flux information associated with the first cleaning.

Any of the aspects herein, further including determining a second membrane resistance after the second cleaning based on second data associated with the second cleaning, wherein the second data includes membrane resistance before the second cleaning, chemical concentrations associated with the second cleaning, flux and total permeate volume associated with the second cleaning (i.e., flux and total permeate volume during the filtration phase before the second cleaning).

Any of the aspects herein, wherein each of the plurality of membrane resistance curves includes information associated with membrane resistance during a membrane operation mode.

Any of the aspects herein, wherein each of the plurality of membrane resistance curves is obtained by calculating the membrane resistance at a flux at a predetermined time interval, and using a regression model (e.g., a linear regression model and/or a non-linear regression model) to determine each of the plurality of membrane resistance curves.

Any of the aspects herein, further including simulating a plurality of membrane resistance records for a predetermined future period based on the first membrane resistance, a second membrane resistance determined after the second cleaning, and the plurality of membrane resistance curves.

Any of the aspects herein, further including determining a chemical cleaning implementation for the predetermined future period based on the plurality of membrane resistance records, wherein the chemical cleaning implementation includes a chemical cleaning schedule and chemical cleaning concentrations.

Any of the aspects herein, wherein determining the chemical cleaning implementation for the predetermined future period includes: performing use optimization associated with each of the plurality of membrane resistance records; and determining the chemical cleaning implementation based on comparison of the cost associated with each of the plurality of membrane resistance records.

Any of the aspects herein, wherein the performing the use optimization associated with each of the plurality of membrane resistance records is based on a set of considerations associated with the first cleaning, the second cleaning, and the chemical cleaning implementation for the predetermined future period. In some aspects, the set of considerations includes, for each of the cleanings: a first consideration associated with energy consumption during a membrane operation mode; and a second consideration including at least one of energy consumption and chemical costs associated with a chemical cleaning concentration (e.g., costs relating to chemical cleaning concentration).

Any of the aspects herein, wherein the first cleaning includes a maintenance cleaning or a recovery cleaning.

Any of the aspects herein, wherein the first membrane resistance and a second membrane resistance determined after the second cleaning includes at least one of a membrane fouling resistance and a membrane initial resistance.

A device including: a processor; and a memory coupled with the processor, wherein the memory stores data that, when executed by the processor, enables the processor to: access a membrane resistance record, wherein the membrane resistance record includes a plurality of membrane resistance curves, each of the plurality of membrane resistance curves includes a curve profile after a cleaning; perform a first cleaning; determine a first membrane resistance after the first cleaning; determine a current position on the curve profile based on the first membrane resistance and a time period from a previous cleaning; and perform a second cleaning. In some aspects, the second cleaning includes: a recovery cleaning when the current position on the curve profile exceeds a predetermined range; and a maintenance cleaning when the current position on the curve profile is within the predetermined range.

Any of the aspects herein, wherein determining the first membrane resistance after the first cleaning is based on first data associated with the first cleaning, wherein the first data includes information associated with at least one of: a membrane resistance before the first cleaning, chemical concentrations associated with the first cleaning, flux associated with the first cleaning, and total permeate volume associated with the first cleaning (i.e., flux and total permeate volume during the filtration phase before the first cleaning).

Any of the aspects herein, wherein the predetermined range is determined based on at least one of transmembrane pressure (TMP) asserted on a membrane and flux information associated with the first cleaning.

Any of the aspects herein, wherein the data is further executable by the processor to determine a second membrane resistance after the second cleaning based on second data associated with the second cleaning, wherein the second data includes membrane resistance before the second cleaning, chemical concentrations, flux and total permeate volume associated with the second cleaning (i.e., flux and total permeate volume during the filtration phase before the second cleaning).

Any of the aspects herein, wherein each of the plurality of membrane resistance curves includes information associated with membrane resistance during a membrane operation mode.

Any of the aspects herein, wherein each of the plurality of membrane resistance curves is obtained by calculating the membrane resistance at a flux at a predetermined time interval, and using a regression model (e.g., a linear regression model and/or a non-linear regression model) to determine each of the plurality of membrane resistance curves.

Any of the aspects herein, wherein the data is further executable by the processor to simulate a plurality of membrane resistance records for a predetermined future period based on the first membrane resistance, a second membrane resistance determined after the second cleaning, and the plurality of membrane resistance curves.

A system including: a processor; and a memory coupled with the processor, wherein the memory stores data that, when executed by the processor, enables the processor to: access a membrane resistance record, wherein the membrane resistance record includes a plurality of membrane resistance curves, each of the plurality of membrane resistance curves includes a curve profile after a cleaning; perform a first cleaning; determine a first membrane resistance after the first cleaning; determine a current position on the curve profile based on the first membrane resistance and a time period from a previous cleaning; and perform a second cleaning. In some aspects, the second cleaning includes: a recovery cleaning when the current position on the curve profile exceeds a predetermined range; and a maintenance cleaning when the current position on the curve profile is within the predetermined range.

### BRIEF DESCRIPTION OF THE DRAWINGS

FIG. 1 illustrates an example of a system that supports optimization of filtration membrane performance in accordance with aspects of the present disclosure.

FIG. 2 illustrates an example block diagram of a system in accordance with aspects of the present disclosure.

FIG. 3 illustrates example implementations of models in accordance with aspects of the present disclosure.

FIGS. 4A and 4B are example graphs in accordance with aspects of the present disclosure.

FIG. 5A illustrates an example process flow in accordance with aspects of the present disclosure. FIG. 5B illustrates an example graph in accordance with aspects of the present disclosure.

FIG. 6A illustrates an example process flow in accordance with aspects of the present disclosure. FIG. 6B illustrates an example block diagram in accordance with aspects of the present disclosure.

FIG. 7 illustrates an example graph in accordance with aspects of the present disclosure.

FIG. 8 illustrates an example process flow that supports optimization of ultra filtration membrane performance in accordance with aspects of the present disclosure.

FIG. 9 illustrates an example block diagram of a system in accordance with aspects of the present disclosure.

### DETAILED DESCRIPTION

There has been a growing demand for the use of new technologies to make water usable alongside existing water resources. For example, new technologies are desired for combating scarcity of water resources due to population growth and restricted natural water sources. In some cases, improving advanced wastewater treatment plants may not only lead to improved water recovery and conservation, but may also reduce costs associated with wastewater treatment. Membrane filtration may play a vital role in such treatment schemes. Some systems may implement membrane filtration techniques as microfiltration (MF), ultrafiltration (UF), nanofiltration (NF), and reverse osmosis (RO).

In some cases, within the filtration types, ultrafiltration technology has been found to exceed current water regulation for turbidity and virus removal. There are two types of ultrafiltration: crossflow ultrafiltration and dead-end ultrafiltration. The advantage of dead-end filtration is high product recovery and relatively simple operation. In dead-end filtration generally utilized in water industry, product recovery is high, but minimizing membrane clogging in the operation is an important factor.

For example, in dead-end ultrafiltration, the fluid to be filtered is fed perpendicularly to a filter element (e.g., a membrane). The entirety of the fluid passes through the filter element, with retained solids forming a cake layer on the surface of the filter element. However, an existing problem in such a separation process is the decline in flux over time due to the fouling of membrane.

Fouling refers to the loss of performance of a membrane due to the deposition of suspended or dissolved substances on external surfaces of the membrane, at pore openings of the membrane, or within the pores. The relation between permeate flux (Jₚ), transmembrane pressure (TMP), fouling resistance (R_{f}), viscosity (μ), and membrane resistance (Rₘ) in a dead-end UF is expressed by Equation (1) below:

$$\\ \begin{matrix}{J}_{p} = \frac{TMP}{μ ( {R}_{f} + {R}_{m} )} & ( 1 )\end{matrix}$$

In some systems, the filter element (also referred to herein as a filter membrane) must be replaced or cleaned when the limiting pressure drop is reached due to fouling. To increase lifespan of the filter element and reduce the cost of energy during production, the fouling (including the formation of the cake layer and pore blocking) can be reduced by periodic backwashing and chemical cleaning. While periodic backwashing may reduce reversible fouling during an operation or production mode of the membrane, chemical cleaning may be applied to address irreversible fouling reduction. Chemical cleaning includes maintenance cleaning and recovery cleaning. In some cases, irreversible fouling reduction is the most important factor affecting cost and lifespan of an ultrafiltration membrane. Techniques for effectively scheduling chemical cleaning to control membrane fouling is desired.

Though some approaches have attempted to optimize the cleaning process, such attempts have been limited to considering a single parameter (e.g., backwash, chemical cleaning, flux setpoints, etc.). In addition, the approaches have not considered the long-term performance of a membrane due to pore blocking resistance, nor the effectiveness of backwashing and chemical cleaning in association with addressing such conditions. Aspects of the present disclosure include optimizing the cleaning implementation by considering backwashing and chemical cleaning at different flux setpoints during a lifecycle of a membrane, thereby reducing the cost of operation and increasing the lifespan of membrane.

Further, in some processing facilities (e.g., water treatment plants), ultrafiltration membranes are widely used. In some cases, the membranes are exposed to membrane fouling, and in some systems, cleaning procedures are frequently implemented to restore the permeability of the membranes. Various cleaning methods have been practiced including backwash and chemical cleaning to prevent reversible and irreversible membrane fouling.

According to example aspects of the present disclosure, membrane resistance during a production mode and after chemical cleaning have been modeled using artificial intelligence, taking into account the impact of backwashing and chemical cleaning at different flux levels (also referred to herein as flux set points). Using the developed models, a system described herein may predict the future fouling resistance for a production mode and after chemical cleaning. Aspects of the techniques described herein support controlling the membrane fouling at different flux levels. In some examples, the system may control the membrane fouling using a sequence of filtration, backwashing, and chemical cleaning. Aspects of the present disclosure incorporate artificial intelligence models to predict membrane fouling resistance.

The total resistance of a membrane is a combination of intrinsic membrane resistance and the fouling resistance due to different phenomena such as pore blocking, cake deposition, or concentration polarization. In some cases, the relation between fouling resistance (R_{f}), intrinsic membrane resistance (Rₘ), permeate flux (Jₚ), transmembrane pressure (TMP), and viscosity (μ) in a dead-end ultrafiltration membrane is expressed by Equation (2) below:

$$\\ \begin{matrix}{R}_{total} = {R}_{m} + {R}_{f} = \frac{TMP}{μ {J}_{p}} & ( 2 )\end{matrix}$$

where Rₜₒₜₐₗ is total resistance which can be predicted using technique described herein by fitting experimental data.

The terms “maintenance cleaning,” “maintenance chemical cleaning,” “chemical cleaning,” and “chemical enhanced backwash (CEB)” may be used interchangeably herein.

The terms “recovery cleaning,” “cleaning in place,” and “offline recovery chemical cleaning” may be used interchangeably herein.

Aspects of the disclosure are initially described in the context of a processing facility such as a water treatment facility including filtration membranes (e.g., ultrafiltration membranes). Examples of processes that support optimization of ultra-filtration membrane performance are then described. Aspects of the disclosure are further illustrated by and described with reference to apparatus diagrams, system diagrams, and flowcharts that relate to optimization of ultra filtration membrane performance.

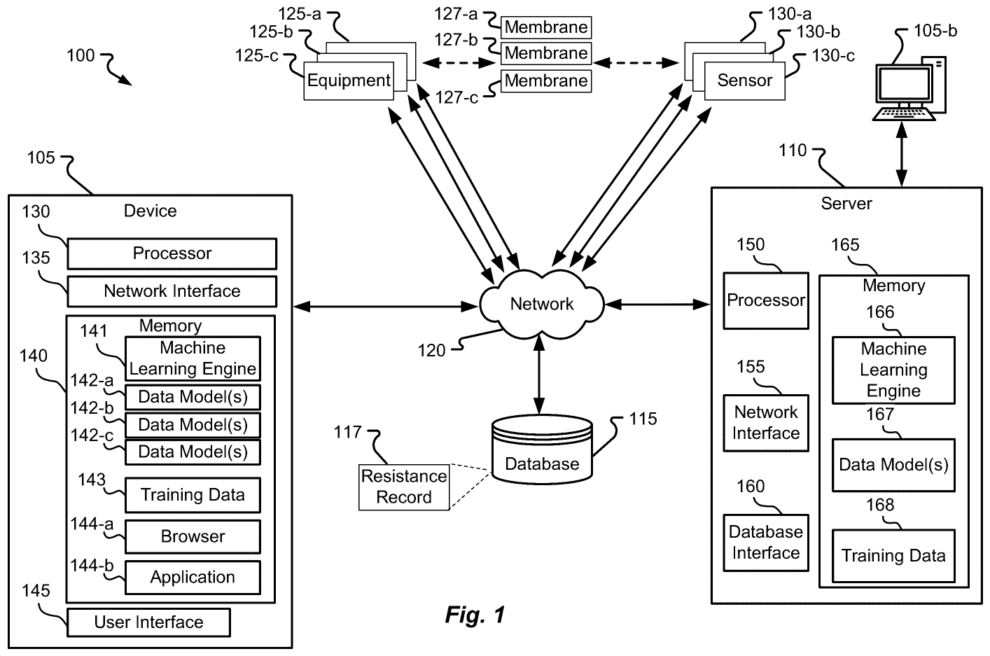

FIG. 1 illustrates an example of a system 100 that supports optimization of ultra filtration membrane performance in accordance with aspects of the present disclosure. In some examples, the system 100 may be a process control system applicable for process control within an industrial environment such as a processing facility.

In some aspects, the system 100 may be a distributed process control system capable of executing and controlling processes associated with manufacturing, conversion, production, other processing (e.g., water treatment, petrochemical, refineries, power plants, etc.), or the like. In some examples, the system 100 may be a distributed process control system including controllers (e.g., implemented by a communication device 105 and/or a server 110) connected to equipment 125 included in the system 100.

The system 100 may include a communication device 105 (or multiple communication devices 105), a server 110, a database 115, a communication network 120, equipment 125, membranes 127, and sensor devices 130. The communication device 105 may be a wireless communication device. Non-limiting examples of the communication device 105 may include, for example, personal computing devices or mobile computing devices (e.g., laptop computers, mobile phones, smart phones, smart devices, wearable devices, tablets, etc.). In some examples, the communication device 105 may be operable by or carried by a human user. In some aspects, the communication device 105 may perform one or more operations autonomously or in combination with an input by the user, another communication device 105, and/or the server 110.

The server 110 may be, for example, a cloud-based server. In some aspects, the server 110 may be a local server connected to the same network (e.g., LAN, WAN) associated with the communication device 105. The database 115 may be, for example, a cloud-based database. In some aspects, the database 115 may be a local database connected to the same network (e.g., LAN, WAN) associated with the communication device 105 and/or the server 110. The database 115 may be supportive of data analytics, machine learning, and AI processing.

The communication network 120 may facilitate machine-to-machine communications between any of the communication device 105 (or multiple communication device 105), the server 110, or one or more databases (e.g., database 115). The communication network 120 may include any type of known communication medium or collection of communication media and may use any type of protocols to transport messages between endpoints. The communication network 120 may include wired communications technologies, wireless communications technologies, or any combination thereof.

The Internet is an example of the communication network 120 that constitutes an Internet Protocol (IP) network consisting of multiple computers, computing networks, and other communication devices located in multiple locations, and components in the communication network 120 (e.g., computers, computing networks, communication devices) may be connected through one or more telephone systems and other means. Other examples of the communication network 120 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 120 may include of any combination of networks or network types. In some aspects, the communication network 120 may include any combination of communication mediums such as coaxial cable, copper cable/wire, fiber-optic cable, or antennas for communicating data (e.g., transmitting/receiving data).

The equipment 125 may include any equipment associated with a processing facility. For example, the equipment 125 may include equipment associated with water treatment (e.g., centrifugal pumps, positive displacement pumps, valves, motors, etc.). In some aspects, the equipment 125 may include or house a membrane 127 (e.g., membrane 127-a) or multiple membranes 127 (e.g., membrane 127-a through membrane 127-c). The membrane 127 may be, for example, an ultrafiltration membrane. Aspects of the present disclosure support implementations using any membrane type suitable for water filtration.

The sensor device 130 (e.g., sensor device 130-a through sensor device 130-c) may include field devices capable of monitoring or measuring the performance (e.g., measuring performance data) associated with the equipment 125. In an example, the sensor devices 130 may include flow sensors, pressure sensors, level sensors, temperature sensors, etc. In some cases, the sensor devices 130 may be mechanically coupled to the equipment 125.

The sensor devices 130 may be, for example, communication devices capable of transmitting and receiving signals (e.g., via wired or wireless communications). For example, each sensor device 130 may be capable of transmitting any measured performance data (i.e., measurement data) to a communication device 105, the database 115, and/or the server 110, for example, via the communications network 120. In some cases, a sensor device 130 may transmit measurement data directly to a communication device 105 (e.g., via a radio frequency (RF) communications link established between the sensor device 130 and the communication device 105, via a wired communication link between the sensor device 130 and the communication device 105, etc.), and the communication device 105 may store the measurement data to the database 115 and/or transmit the measurement data to the server 110.

For example, the sensor devices 130 may measure any parameter suitable for determining lifespan and/or performance of the membrane 127. For example, the sensor devices 130 may support the measurement of fouling resistance (R_{f}), intrinsic membrane resistance (Rₘ), permeate flux (Jₚ), transmembrane pressure (TMP), and viscosity (μ), but are not limited thereto. Other examples of parameters measurable or derivable by the sensor devices 130 are described with reference to the following figures.

In some cases, equipment 125-a through equipment 125-c may operate in the same group, and two or more of equipment 125-a through equipment 125-c may be in operation at a time based on performance demand and/or scheduling (e.g., shift).

Various sensor device configurations may be implemented in accordance with aspects of the present disclosure. For example, some sensor devices 130 may measure parameters corresponding to individual equipment 125 (e.g., equipment 125-a), a group of equipment 125 (e.g., equipment 125-a through equipment 125-c), an individual membrane 127, or multiple membranes 127. According to example aspects of the present disclosure, the system 100 may support predictive modeling of parameters (e.g., resistance of a membrane 127), example aspects of which are later described herein.

In various aspects, settings of the any of the communication devices 105, the server 110, database 115, the communication network 120, the equipment 125, and the sensor devices 130 may be configured and modified by any user and/or administrator of the system 100. Settings may include thresholds or parameters described herein, as well as settings related to how data is managed. Settings may be configured to be personalized for one or more communication devices 105, users of the communication devices 105, and/or other groups of entities, and may be referred to herein as profile settings, user settings, or organization settings. In some aspects, rules and settings may be used in addition to, or instead of, parameters or thresholds described herein. In some examples, the rules and/or settings may be personalized by a user and/or administrator for any variable, threshold, user (user profile), communication device 105, entity, or groups thereof.

Aspects of the communication devices 105 and the server 110 are further described herein. A communication device 105 (e.g., communication device 105-a) may include a processor 130, a network interface 135, a memory 140, and a user interface 145. In some examples, components of the communication device 105 (e.g., processor 130, network interface 135, memory 140, user interface 145) may communicate over a system bus (e.g., control busses, address busses, data busses) included in the communication device 105. In some cases, the communication device 105 may be referred to as a computing resource.

In some cases, the communication device 105 may transmit packets to or receive packets from one or more other devices (e.g., another communication device 105, the server 110, the database 115, equipment 125, a sensor device 130) via the communication network 120, using the network interface 135. The network interface 135 may include, for example, any combination of network interface cards (NICs), network ports, associated drivers, or the like. Communications between components (e.g., processor 130, memory 140) of the communication device 105 and one or more other devices (e.g., another communication device 105, the database 115, equipment 125, a sensor device 130) connected to the communication network 120 may, for example, flow through the network interface 135.

The processor 130 may correspond to one or many computer processing devices. For example, the processor 130 may include a silicon chip, such as a FPGA, an ASIC, any other type of IC chip, a collection of IC chips, or the like. In some aspects, the processors may include a microprocessor, CPU, a GPU, or plurality of microprocessors configured to execute the instructions sets stored in a corresponding memory (e.g., memory 140 of the communication device 105). For example, upon executing the instruction sets stored in memory 140, the processor 130 may enable or perform one or more functions of the communication device 105.

The memory 140 may include one or multiple computer memory devices. The memory 140 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 140, in some examples, may correspond to a computer-readable storage media. In some aspects, the memory 140 may be internal or external to the communication device 105.

The processor 130 may utilize data stored in the memory 140 to train artificial intelligence (AI)/machine learning (ML) models. The AI/ML models may include a machine learning algorithm or artificial intelligence algorithm. In some aspects, the AI/ML models may be or include an artificial neural network (ANN). In some other aspects, the AI/ML models may be or include any machine learning algorithms such as, for example, a deep learning network, a convolutional neural network, or the like. Some elements stored in memory 140 may be described as or referred to as instructions or instruction sets, and some functions of the communication device 105 may be implemented using AI/ML techniques.

The memory 140 may be configured to store instruction sets, AI/ML models, and other data structures (e.g., depicted herein) in addition to temporarily storing data for the processor 130 to execute various types of routines or functions. For example, the memory 140 may be configured to store program instructions (instruction sets) that are executable by the processor 130 and provide functionality of machine learning engine 141 described herein. The memory 140 may also be configured to store data or information that is useable or capable of being called by the instructions stored in memory 140. One example of data that may be stored in memory 140 for use by components thereof is a data model(s) 142 (e.g., a neural network model, AI/ML model, or other model described herein) and/or training data 143 (also referred to herein as a training data and feedback).

The machine learning engine 141 (also referred to herein as an AI/ML engine 141) may include a single or multiple engines. The communication device 105 (e.g., the machine learning engine 141) may utilize one or more data models 142 for recognizing and processing information obtained from other communication devices 105, the server 110, equipment 125, sensor devices 130, and the database 115. In some aspects, the communication device 105 (e.g., the machine learning engine 141) may update one or more data models 142 based on learned information included in the training data 143. In some aspects, the machine learning engine 141 and the data models 142 may support predictive learning/analysis based on the training data 143. The machine learning engine 141 may have access to and use one or more data models 142.

The data model(s) 142 may be built and updated by the machine learning engine 141 based on the training data 143. The data model(s) 142 may be provided in any number of formats or forms. Non-limiting examples of the data model(s) 142 include Decision Trees, Support Vector Machines (SVMs), Nearest Neighbor, and/or Bayesian classifiers. In some aspects, the data model(s) 142 may include a predictive model such as a linear regression model or a non-linear regression model (e.g., an autoregressive model). Other example aspects of the data model(s) 142, such as generating (e.g., building, training) and applying the data model(s) 142, are described with reference to the figure descriptions herein.

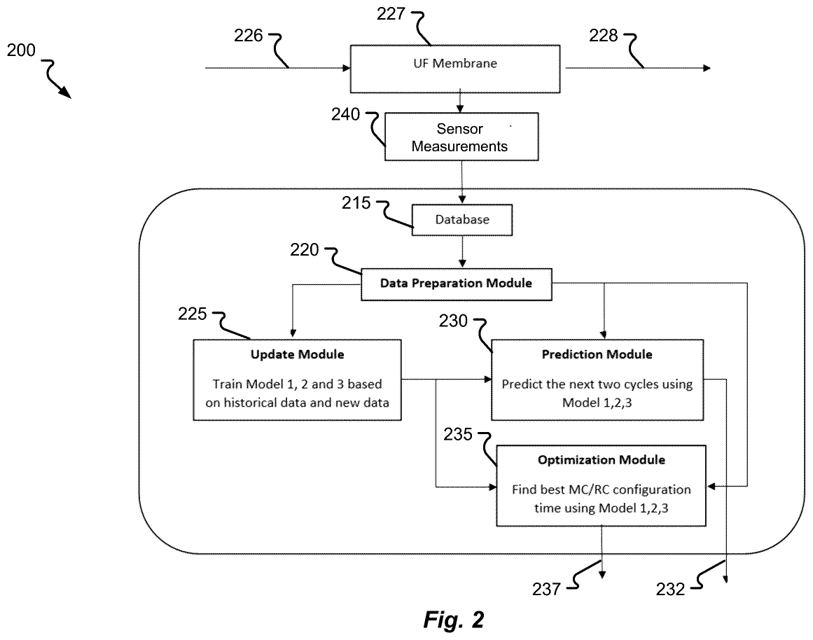

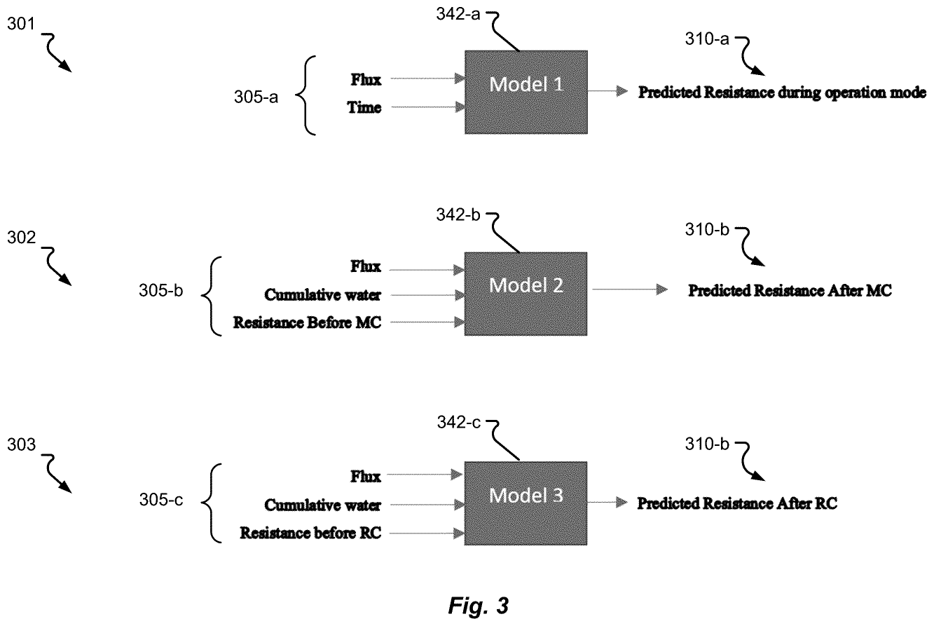

According to aspects of the present disclosure, the data model(s) 142 may include a model 142-a trained to simulate resistance of the membrane 127 during an operational mode thereof, a model 142-b trained to predict resistance of the membrane 127 after implementing a maintenance cleaning, and a model 142-c trained to predict a resistance of the membrane 127 after implementing a recovery cleaning, examples of which are at least described herein with reference to FIGS. 2 and 3.

In some examples, the training data 143 may include aggregated measurement data (e.g., current measurement values, previous measurement values) recorded by the sensor devices 130. In some aspects, the aggregated measurement data may include measurement data recorded with respect to one or more temporal periods and/or one or more parameters (e.g., performance parameters) associated with the equipment 125.

In some cases, the training data 143 may include performance data predicted by the machine learning engine 141 (i.e., supportive of predictive learning/analysis). The predicted performance data may include, for example, predicted faults associated with the equipment 125, temporal information (e.g., predicted temporal instances, predicted temporal durations, etc.) associated with the predicted faults, causal information associated with the predicted faults, or the like. Example aspects of the training data 143 are later described herein.

In some cases, the training data 143 may include reference performance data associated with the equipment 125 and/or the membrane 127 with respect to a set of operating conditions and a temporal period (e.g., a reference period). In an example, the operating conditions may include normal operating conditions (also referred to herein as a stable period or baseline conditions) with respect to the system 100, the equipment 125, and/or the membrane 127. In some other aspects, the machine learning engine 141 may be configured to analyze performance data predicted by the machine learning engine 141 (i.e., supportive of predictive learning/analysis).

The machine learning engine 141 may analyze any information (e.g., measured performance data, predicted performance data, parameters, and/or configurations) described herein that is historical or in real-time. The machine learning engine 141 may be configured to receive or access information from the communication device 105, the server 110, the database 115, the equipment 125, and/or the sensor devices 130. The machine learning engine 141 may build any number of profiles such as, for example, profiles associated with the system 100 (e.g., profiles associated with a processing facility), profiles associated with equipment 125, profiles associated with a sensor device 130, etc. using automatic processing, using artificial intelligence and/or using input from one or more users associated with the communication device 105. The profiles may be, for example, configuration profiles, performance profiles, etc. The machine learning engine 141 may use automatic processing, artificial intelligence, and/or inputs from one or more users of the communication devices 105 to determine, manage, and/or combine information relevant to a configuration profile.

The machine learning engine 141 may determine configuration profile information based on a user's interactions with information. The machine learning engine 141 may update (e.g., continuously, periodically) configuration profiles based on new information that is relevant. The machine learning engine 141 may receive new information from any communication device 105, the server 110, the database 115, the equipment 125, the sensor devices 130, etc. Profile information may be organized and classified in various manners. In some aspects, the organization and classification of configuration profile information may be determined by automatic processing, by artificial intelligence and/or by one or more users of the communication devices 105.

The machine learning engine 141 may create, select, and execute appropriate processing decisions. Example processing decisions may include analysis of measured performance data, predicted performance data, configuration of a communication device 105, configuration of equipment 125, and/or configuration of a sensor device 130. Processing decisions may be handled automatically by the machine learning engine 141, with or without human input.

The machine learning engine 141 may store, in the memory 140 (e.g., in a database included in the memory 140), historical information (e.g., reference data, measurement data, predicted performance data, deviation values, configurations, etc.). Data within the database of the memory 140 may be updated, revised, edited, or deleted by the machine learning engine 141. In some aspects, the machine learning engine 141 may support continuous, periodic, and/or batch fetching of data (e.g., from equipment 125, membranes 127, sensor devices 130, a central controller, communication devices 105, etc.) and data aggregation.

The communication device 105 may render a presentation (e.g., visually, audibly, using haptic feedback, etc.) of an application 144 (e.g., a browser application 144-a, an application 144-b). The application 144-b may be an application associated with executing, controlling, and/or monitoring equipment 125, membranes 127 of the system 100 as described herein. For example, the application 144-b may enable control of the communication device 105, equipment 125, and/or sensor devices 130 described herein.

In an example, the communication device 105 may render the presentation via the user interface 145. The user interface 145 may include, for example, a display (e.g., a touchscreen display), an audio output device (e.g., a speaker, a headphone connector), or any combination thereof. In some aspects, the applications 144 may be stored on the memory 140. In some cases, the applications 144 may include cloud-based applications or server-based applications (e.g., supported and/or hosted by the database 115 or the server 110). Settings of the user interface 145 may be partially or entirely customizable and may be managed by one or more users, by automatic processing, and/or by artificial intelligence.

In an example, any of the applications 144 (e.g., browser application 144-a, application 144-b) may be configured to receive data in an electronic format and present content of data via the user interface 145. For example, the applications 144 may receive data from another communication device 105, the server 110, the database 115, equipment 125, and/or sensor devices 130 via the communications network 120, and the communication device 105 may display the content via the user interface 145.

The database 115 may include a relational database, a centralized database, a distributed database, an operational database, a hierarchical database, a network database, an object-oriented database, a graph database, a NoSQL (non-relational) database, etc. In some aspects, the database 115 may store and provide access to, for example, any of the stored data described herein.

The server 110 may include a processor 150, a network interface 155, database interface 160, and a memory 165. In some examples, components of the server 110 (e.g., processor 150, network interface 155, database interface 160, memory 165) may communicate over a system bus (e.g., control busses, address busses, data busses) included in the server 110. The processor 150, network interface 155, and memory 165 of the server 110 may include examples of aspects of the processor 130, network interface 135, and memory 140 of the communication device 105 described herein.

For example, the processor 150 may be configured to execute instruction sets stored in memory 165, upon which the processor 150 may enable or perform one or more functions of the server 110. In some examples, the server 110 may transmit packets to or receive packets from one or more other devices (e.g., a communication device 105, the database 115, another server 110) via the communication network 120, using the network interface 155. Communications between components (e.g., processor 150, memory 165) of the server 110 and one or more other devices (e.g., a communication device 105, the database 115, equipment 125, a sensor device 130, etc.) connected to the communication network 120 may, for example, flow through the network interface 155.

The database interface 160 may also be referred to herein as database interface instructions 160. In some examples, the database interface instructions 160, when executed by the processor 150, may enable the server 110 to send data to and receive data from the database 115. For example, the database interface instructions 160, when executed by the processor 150, may enable the server 110 to generate database queries, provide one or more interfaces for system administrators to define database queries, transmit database queries to one or more databases (e.g., database 115), receive responses to database queries, access data associated with the database queries, and format responses received from the databases for processing by other components of the server 110.

The memory 165 may be configured to store instruction sets, neural networks, and other data structures (e.g., depicted herein) in addition to temporarily storing data for the processor 150 to execute various types of routines or functions. For example, the memory 165 may be configured to store program instructions (instruction sets) that are executable by the processor 150 and provide functionality of a machine learning engine 166. One example of data that may be stored in memory 165 for use by components thereof is a data model(s) 167 (e.g., any data model described herein, a neural network model, etc.) and/or training data 168.

The data model(s) 167 and the training data 168 may include examples of aspects of the data model(s) 142 and the training data 143 described with reference to the communication device 105. The machine learning engine 166 may include examples of aspects of the machine learning engine 141 described with reference to the communication device 105. For example, the server 110 (e.g., the machine learning engine 166) may utilize one or more data models 167 for recognizing and processing information obtained from communication devices 105, another server 110, the database 115, the equipment 125, and/or the sensor devices 130. In some aspects, the server 110 (e.g., the machine learning engine 166) may update one or more data models 167 based on learned information included in the training data 168.

In some aspects, components of the machine learning engine 166 may be provided in a separate machine learning engine in communication with the server 110.

Example aspects of the present disclosure may include applying advances in data storage technologies (e.g., implemented at the memory 140, database 115, and/or memory 165) with smart sensors (e.g., sensor devices 130) to capture and store all the relevant data pertaining to any equipment/process. For example, the techniques described herein may include applying one or more mechanisms to extract actionable insight (e.g., predicted resistance of a membrane 127, etc.) from the data and provide situational recommendations (e.g., recommended operator actions, recommended maintenance actions such as when to implement a maintenance cleaning and/or a recovery cleaning) based on the extracted insight.

FIG. 2 illustrates an example block diagram of a system 200 that supports optimization of ultra filtration membrane performance in accordance with aspects of the present disclosure. In some examples, the system 200 may implement aspects of system 100. For example, aspects of the system 200 may be implemented by a server 110 and/or a communication device 105 described with reference to FIG. 1.

The system 200 may include a database 215, a data preparation module 220, an update module 225, a prediction module 230, and an optimization module 235. The system 200 may include a membrane 227 and sensors (e.g., sensors 130 described with reference to FIG. 1) capable of providing sensor measurements 240 associated with the membrane 227. The system 200 (and components thereof) may include examples of aspects like elements described herein.

The system 200 may process the sensor measurements 240 provided by the sensors and/or store the sensor measurements 240 to database 215. The sensor measurements 240 may include measured values corresponding to one or more parameters associated with a membrane 227. In some aspects, the sensor measurements 240 may include real-time measured values corresponding to the parameters.

In some aspects, the sensor measurements 240 may include values corresponding to one or more of process parameters (e.g., temperature, pressure, level, flow, etc.), flow rate, flux set points, temperature parameters, and pressure parameters. For example, the sensor measurements 240 may include permeate flux (Jₚ), transmembrane pressure (TMP), temperature and turbidity associated with the membrane 227 and/or a fluid (e.g., water) flowing through the membrane 227. In some aspects, the sensor measurements 240 may include an input flow 226 of liquid (e.g., water) and an output flow 228 of permeate (e.g., water) at the membrane 227. In an example, the system 200 may calculate a total resistance (Rₜₒₜₐₗ) from a combination of the sensor measurements 240, as described herein with reference to Equation (2).

The data preparation module 220 may support features for preparing data associated with training and/or updating various models (e.g., model 142-a through model 142-c described with reference to FIG. 1, also referred to herein as “Model 1” through “Model 3”). Example aspects of the data preparation are later described herein.

The update module 225 may support features associated with training and/or updating the various models based on the data provided by the data preparation module 220. Example aspects of training and/or updating the models are later described herein.

The prediction module 230 may support features of providing a resistance 232 of the membrane 227, predicted in association with an operational mode (also referred to herein as a production mode), a maintenance cleaning, and/or a recovery cleaning. In an example, the prediction module 230 may predict the resistance 232 in association with the operational mode, using the model 142-a (Model 1). In another example, the prediction module 230 may predict the resistance 232 in association with the maintenance cleaning, using the model 142-b (Model 2). In another example, the prediction module 230 may predict the resistance 232 in association with the recovery cleaning, using the model 142-c (Model 3). Example aspects of predicting the resistance 232 using the models 142 are later described herein.

The optimization module 235 may support features of exploration of multiple configurations in which maintenance cleanings and recovery cleanings are implemented. For example, the system 200 may apply the models 142 and an optimization algorithm in association with determining a configuration 237 (e.g., a “best” maintenance cleaning/recovery cleaning configuration) capable of achieving a target performance of the membrane 227, while at the same time optimizing the cost. In some aspects, the optimization algorithm may include a metaheuristic algorithm e.g., Genetic Algorithm. Example aspects of applying the optimization algorithm in association with determining the configuration 237 are later described herein.

FIG. 3 illustrates example implementations 301 through 303 of models 342 (e.g., model 342-a, model 342-b, model 342-c) that support optimization of ultra filtration membrane performance in accordance with aspects of the present disclosure.

Aspects of the present disclosure include providing an input 305 to each of models 342 and generating a corresponding output 310. Models 342 may be implemented, for example, at system 100 and system 200 described with reference to FIGS. 1 and 2. Aspects of the models 342 may include aspects of like elements (e.g., model 142-a through model 142-c of FIG. 1) described herein.

The models 342 may support optimization of maintenance cleaning and/or recovery cleaning implementations (e.g., cleaning frequency, chemical concentration, etc.) with respect to the status of a membrane 127 described with reference to FIG. 1. For example, optimization of the maintenance cleaning and/or recovery cleaning may extend the life of the membrane 127 (e.g., in units of resistance, resistance accuracy of 0.1/permeability loss, etc.). In association with optimizing maintenance cleaning and/or recovery cleaning implementations, the system 100 may process historical data of the membrane 127. The system 100 may obtain the historical data, for example, from a database 115 and/or resistance record 117 described with reference to FIG. 1.

The system 100 may process factors identified by the system 100 (or identified by an operator of the system 100) as relatively the most important or impactful in association with membrane clogging and/or fouling. Using the models 342, the system 100 may calculate a membrane resistance of the membrane 127 in association with different temporal instances or different events (e.g., during production mode or after a chemical cleaning).

For example, the model 342-a (also referred to herein as ‘Model 1’) may process input data 305-a associated with the membrane 127 and provide corresponding output data 310-a. The input data 305-a may include a measured flux of the membrane 127 and a time (e.g., temporal instance, quantity of days) associated with the measured flux or any other parameters related to total resistance or membrane fouling resistance. The flux of the membrane 127 is defined as the volume of permeate produced per unit area of a surface of the membrane 127 per unit of time.

The output data 310-a may include a predicted resistance of the membrane 127 during an operation mode. The operation mode may also be referred to as a production mode. The operation mode may include operation of the equipment 125 of FIG. 1 using the membrane 217 (e.g., before and/or after a maintenance cleaning of the membrane 127, before and/or after a recovery cleaning of the membrane 127, or the like). Accordingly, for example, the model 342-a is a model trained to simulate/predict resistance of the membrane 127 during an operational mode thereof. The terms “operational mode” and “production mode” may be used interchangeably herein.

In another example, the model 342-b (also referred to herein as ‘Model 2’) may process input data 305-b associated with the membrane 127 and provide corresponding output data 310-b. The input data 305-b may include a measured flux of the membrane 127, a cumulative amount of a liquid (e.g., water), concentration of chemical solutions used in the maintenance cleaning, and a current resistance of the membrane 127 (e.g., prior to implementing a maintenance cleaning). The cumulative amount of the liquid (e.g., water) includes a cumulative amount of liquid that has already been processed by the membrane 127 from a previous maintenance cleaning (e.g., the most recent maintenance cleaning) to current state of the membrane. The output data 310-b may include a predicted resistance of the membrane 127 after implementing the maintenance cleaning. Accordingly, for example, the model 342-b is a model trained to predict, based on input data 305-b prior to a maintenance cleaning, resistance of the membrane 127 after implementing the maintenance cleaning.

In another example, the model 342-c (also referred to herein as ‘Model 3’) may process input data 305-c associated with the membrane 127 and provide corresponding output data 310-c. The input data 305-c may include a measured flux of the membrane 127, a cumulative amount of a liquid (e.g., water), concentration of chemical solutions used in the recovery cleaning, and a current resistance of the membrane 127 (e.g., prior to implementing a recovery cleaning). The output data 310-c may include a predicted resistance of the membrane 127 after implementing the recovery cleaning. Accordingly, for example, the model 342-c is a model trained to predict, based on input data 305-c prior to a recovery cleaning, resistance of the membrane 127 after implementing the recovery cleaning.

The system 100 may apply the models 342 to simulate equipment operation using the membrane 127 over a temporal period (e.g., a temporal duration of one month). The system 100 may simulate the equipment operation from a first temporal instance (e.g., a current temporal instance) to a target temporal instance (e.g., a duration of one month).

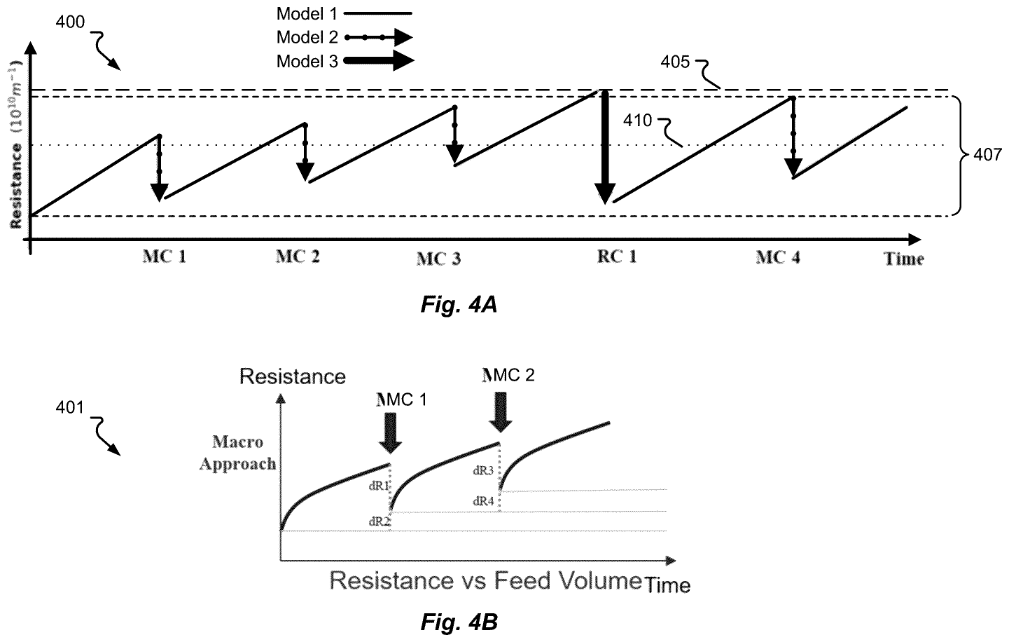

FIG. 4A illustrates an example graph 400 of simulation results using the models 342 described with reference to FIG. 3. As illustrated in FIG. 4A, using model 342-a (e.g., Model 1), the system 100 may predict the resistance (e.g., in units of 10¹⁰ m⁻¹) of the membrane 127 during an operation mode of equipment 125 with respect to time. For example, the system 100 may predict increases in the resistance of the membrane 127 with respect to time. In some examples, using model 342-b (e.g., Model 2), the system 100 may predict the resistance of the membrane 127 after implementing a maintenance cleaning (e.g., MC 1, MC 2, MC 3, MC 4, etc.). In another example, using model 342-c (e.g., Model 3), the system 100 may predict the resistance of the membrane 127 after implementing a recovery cleaning (e.g., RC 1).

Aspects of the present disclosure support exploration of multiple configurations in which maintenance cleanings and recovery cleanings are implemented. For example, the system 100 may apply the models 342 and an optimization algorithm in association with achieving a target performance of the membrane 127 while at the same time minimizing the operational and maintenance costs.

The target performance may include for example, a target rate of reduction in resistance. In some aspects, the target performance may include a threshold resistance 405 at which to implement a recovery cleaning (e.g., RC 1). In some aspects, the target performance may include a target resistance range 407 for which to implement a maintenance cleaning (e.g., MC 1, MC 2, MC 3, MC 4). In an example, the threshold resistance 405 may exceed (be outside of) the target resistance range 407.

In some examples, the target performance may include a target average resistance 410 over time. In some aspects, the target performance may include a target resistance value after recovery cleaning (e.g., a minimum resistance value which satisfies a minimum permeability loss within a period of time).

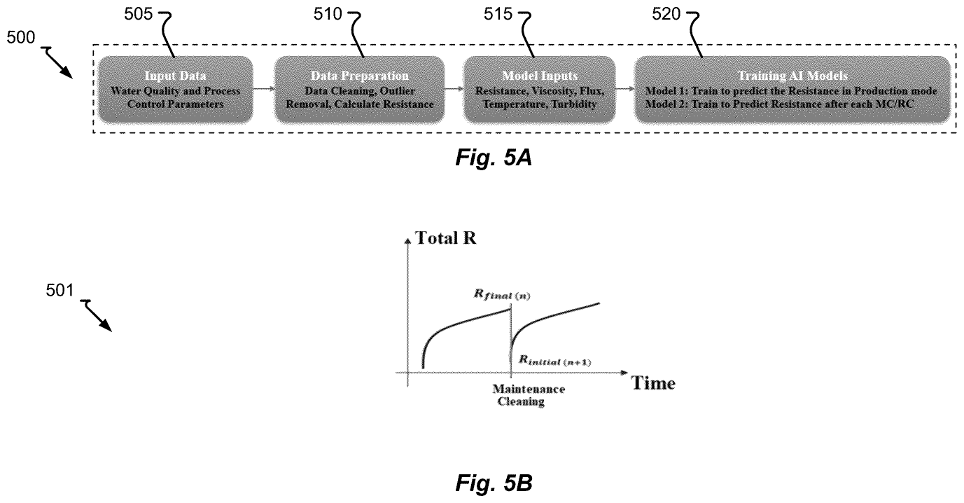

In some aspects, the optimization algorithm may include a metaheuristic optimization algorithm (e.g., genetic algorithm). According to example aspects of the present disclosure, using the optimization algorithm, the system 100 may execute multiple simulations, based on which the system 100 may generate (e.g., calculate and/or predict) an total resistance over time. In some aspects, based on results of the simulations, the system 100 may generate (e.g., calculate and/or predict) an average resistance over a period of time. Example aspects of a final resistance are later described with reference to FIG. 5B.

For example, the system 100 may identify parameters, which, if implemented in association with implementing maintenance cleanings and/or recovery cleanings, may achieve a target performance (e.g., target rate of reduction in resistance, target average resistance 410 over time, etc.) of the membrane 127. Accordingly, for example, the system 100 may identify a quantity of cleanings (e.g., maintenance cleanings, recovery cleanings) and threshold criteria for implementing the cleanings. In an example, the threshold criteria may include the threshold resistance 405, temporal information, and/or periodicity for implementing the cleanings.

In an example referring to FIG. 4A, MC 1 may correspond to a concentration of e.g., 300 mg/L sodium hypochlorite (at Flux 30) on day 3, MC 2 may correspond to a concentration, e.g., 400 mg/L sodium hypochlorite (at Flux 30) on day 7, MC 3 may correspond to a concentration, e.g., 700 mg/L sodium hypochlorite (at Flux 30) on day 15, RC 1 may correspond to a concentration, e.g., 2000 mg/L sodium hypochlorite (at Flux 30) on day 20, and MC 4 may correspond to a concentration 300 (Flux 30) on day 25.

FIG. 4B is an example graph 401 of simulation results using the models 342. As illustrated in FIG. 4B, using model 342-a (e.g., Model 1), the system 100 may predict the resistance of the membrane 127 during an operational mode of the membrane 127 with respect to time. Using model 342-b (e.g., Model 2), the system 100 may predict the resistance of the membrane 127 after implementing a maintenance cleaning (e.g., MC 1, MC 2, etc.). FIG. 4B illustrates examples of reductions in resistance (e.g., dR1 to dR2, dR3 to dR4) resulting from the maintenance cleanings.

FIG. 5A illustrates a process flow 500 that supports model training in accordance with aspects of the present disclosure. In some examples, the process flow 500 may implement aspects of system 100. For example, the process flow 500 may be implemented by equipment 125, a server 110 and/or a communication device 105 as described with reference to FIG. 1.

According to example aspects of the process flow 500, the system 100 may train a first model (‘Model 1’) and a second model (‘Model 2’) on historical data. The first model and the second model may include examples of aspects of model 142-a and model 142-b described with reference to FIG. 1. In some aspects, the system 100 may train the first model (‘Model 1’) to model fouling resistance of the membrane 127 with respect to time, during production mode. In some aspects, the system 100 may train the second model (‘Model 2’) to model the fouling resistance of the membrane 127 after implementation of a maintenance cleaning and/or recovery cleaning.

At 505, the system 100 may initiate the training phase started by collecting input data. For example, the system 100 may collect real-time data from a membrane 127 (e.g., a low-pressure membrane) at a processing facility, over a temporal period. For example, the system 100 may collect real-time data from the membrane 127 in a pilot water treatment plant set-up for a temporal period of one year. In an example, during the temporal period, chemical and backwash cleaning (e.g., maintenance cleaning) have been applied to the membrane 127 frequently (e.g., above a threshold quantity with respect to the temporal period). In some aspects, the system 100 may obtain the data from a database (e.g., database 115 of FIG. 1).

The input data collected at 505 may include water quality and process control parameters. In an example, the input data may include values of different process parameters, flow rate, flux set points, temperature parameters, and pressure parameters collected during the temporal period. In some aspects, the system 100 may record the values to the database 115 (e.g., for later processing) or process the values in real-time. In an example, the input data may include permeate flux (Jₚ), transmembrane pressure (TMP), temperature, and turbidity associated with the membrane 127.

At 510, the system 100 may prepare data associated with training the first model (‘Model 1’) and the second model (‘Model 2’). Data preparation may include, for example, data cleaning, outlier removal, and resistance calculations using Equation (2). At 510, the system 100 may process the input data collected at 505. In an example, at 510, processing the input data may include calculating the total resistance (Rₜₒₜₐₗ) of the membrane 127 during production mode, using Equation (2) described herein.

At 515, the system 100 may provide model inputs in association with training the first model (‘Model 1’) and the second model (‘Model 2’) (e.g., relevant model inputs required in association with training the first model (‘Model 1’) and the second model (‘Model 2’)). The model inputs may include, for example, resistance (e.g., fouling resistance (R_{f}), total resistance (Rₜₒₜₐₗ), viscosity (μ) of a liquid flowing through the membrane 127, permeate flux (Jₚ) of the liquid, temperature of the liquid, and/or turbidity of the liquid, and other parameters related to membrane performance.

At 520, the system 100 may train the first model (‘Model 1’) and the second model (‘Model 2’) based on the model inputs of 515. For example, the system 100 may train the first model (‘Model 1’) to predict the total resistance (Rₜₒₜₐₗ) of the membrane 127 during production mode (as a function of flux at different time intervals). In some aspects, the system 100 may train the second model (‘Model 2’) to predict the fouling resistance or total resistance (Rₜₒₜₐₗ) of the membrane 127 after a maintenance cleaning and/or recovery cleaning, based on the fouling resistance or total resistance of the membrane before the cleaning, cumulative volume of permeate produced in the previous production phase, and concentration of the chemical solutions used in the cleaning.

FIG. 5B is a graph 501 of the resistance of a membrane (e.g., membrane 127), as predicted by the system 100 using the first model (‘Model 1’) and the second model (‘Model 2’). FIG. 5B illustrates example predicted behavior of total resistance (Rₜₒₜₐₗ) of the membrane 127 during production mode and after a maintenance cleaning. For example, using the first model (‘Model 1’) and the second model (‘Model 2’), the system 100 may predict the fouling resistance or total resistance (Rₜₒₜₐₗ) of the membrane 127 for production mode and after maintenance cleaning. Total resistance (Rₜₒₜₐₗ) is a combination of fouling resistance and intrinsic membrane resistance.

In some aspects, in training the second model (‘Model 2’), the system 100 calculates the fouling resistance or total resistance (Rₜₒₜₐₗ) before and after maintenance cleaning, as shown in FIG. 5B.

In some aspects, the system 100 may train both the first model (‘Model 1’) and the second model (‘Model 2’) on historical data. The historical data may include data in association with production mode, backwash, maintenance cleaning, and recovery cleaning. In an example, backwash of a duration about 2-3 min was implemented every 20 minutes with filtration permeate, and filtration permeate was also used for maintenance cleaning and recovery cleaning.

In maintenance cleaning, different sodium hypochlorite concentrations may be used. In an example, in maintenance cleaning, the concentration may be varied from 300 mg/L to 700 mg/L. In a specific example, 500 mg/L sodium hypochlorite was dosed and soaked 30 minutes. Maintenance cleaning intervals were set to 3 and 7 days by facility personnel (e.g., plant operators). In recovery cleaning, 2,000 mg/L sodium hypochlorite was dosed and soaked 2 hours. Recovery cleaning was further implemented using 2,000 mg/L citric acid soaked alternately after the cleaning with the sodium hypochlorite. Recovery cleaning intervals were set to one month by facility personnel.

In FIG. 5B, R_{final}(n) is the final resistance of the membrane 127 in an n^{th} production cycle, prior to implementing a maintenance cleaning. Rᵢₙᵢₜᵢₐₗ(n+1) is the initial resistance of the membrane 127 in a next production cycle following the maintenance cleaning.

In some aspects, the second model (‘Model 2’) is a supervised AI model capable of estimating the reduction in resistance (e.g., total resistance (Rₜₒₜₐₗ)) of the membrane 127 after each maintenance cleaning. Using the first model (‘Model 1’) and the second model (‘Model 2’) as described herein, the system 100 may predict the future performance of the membrane 127 (or any membrane 127 of the system 100). Based on the predictions, an operator of the system 100 (e.g., a processing facility) may decide temporal intervals for implementing maintenance cleanings in a way that maximizes the rate of reduction of the membrane resistance and subsequently, reduces overhead costs (e.g., production costs) associated with system 100.

The model training described with reference to FIG. 5A may be referred to as a “first phase” of training. Modeling/predicting the resistance as described with reference to FIG. 5B may be referred to as a “second phase” of training.

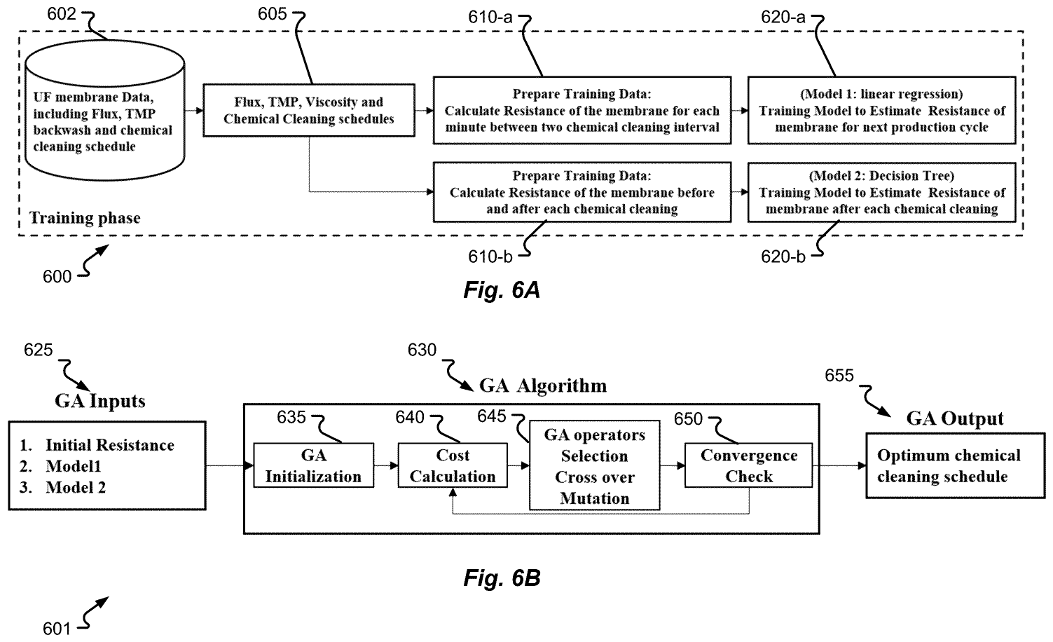

FIG. 6A illustrates a process flow 600 that supports model training in accordance with aspects of the present disclosure. The process flow 600 is an example of a training phase which includes (1) modelling the resistance of a membrane 127 during an operational mode of the membrane 127 and (2) modelling the resistance of membrane 127 after a chemical cleaning, which includes maintenance cleaning and recovery cleaning.

FIG. 6B illustrates a block diagram 601 that supports optimization associated with cleaning the membrane 127 in accordance with aspects of the present disclosure. The process flow 601 is an example of an optimization phase which applies an optimization algorithm (e.g., a genetic algorithm) to find the optimum points for chemical cleaning (e.g., recovery cleaning) during a predefined period of operation of the membrane 127.

In some examples, the process flows 600 and 601 may implement aspects of system 100. For example, the process flows 600 and 601 may be implemented by equipment 125, a server 110 and/or a communication device 105 as described with reference to FIG. 1. Example aspects of the process flows 600 and 601 may include aspects of like elements described herein.

Referring to the process flow 600 of FIG. 6A, the system 100 may collect data 602 in real-time in association with a membrane 127 (e.g., an ultrafiltration membrane) over a predefined temporal period (e.g., one year) and store the data in a database (e.g., database 115 of FIG. 1). In an example, during the temporal period, backwash and chemical cleaning have been applied to the membrane 127 frequently (e.g., above a threshold quantity with respect to the temporal period). The data 602 may include, for example, values of different process parameters, flow rate, flux set points, temperature parameters, and pressure parameters, e.g., feed and filtrate pressure. In some aspects, the system 100 may collect the data 602 from one or more sensors (e.g., sensors 130 of FIG. 1).

At 605, the system 100 may provide (from the data 602), data including: flux information, transmembrane pressure (TMP) asserted on a membrane 127, viscosity associated with a fluid (e.g., water) flowing through the membrane 127 and cleaning schedules implemented in association with cleaning (e.g., maintenance cleaning) the membrane 127.

At 610-a and 610-b, the process flow 600 includes preparing training data from the data provided at 605.

For example, at 610-a, the system 100 may calculate the total resistance (Rₜₒₜₐₗ) of the membrane 127 at a set of temporal instances during a temporal period corresponding to a production mode. The production mode may span a temporal period between a first maintenance cleaning and a second maintenance cleaning. In an example, the system 100 may calculate the total resistance (Rₜₒₜₐₗ) of the membrane 127 for each minute during the temporal period. The system 100 may calculate the total resistance (Rₜₒₜₐₗ) using Equation (2) described herein. In some aspects, the resistance (e.g., total resistance (Rₜₒₜₐₗ)) of the membrane 127 during the operational mode of the membrane 127, as calculated at 610-a, may follow a linear increment (e.g., increase linearly with respect to time).

In another example, at 610-b, the system 100 may calculate the total resistance (Rₜₒₜₐₗ) of the membrane 127 at a temporal instance corresponding to the first maintenance cleaning and a temporal instance corresponding to the second maintenance cleaning.

At 620-a and 620-b, the process flow 600 includes training the first model (‘Model 1’) and the second model (‘Model 2’). The first model (‘Model 1’) may be referred to as an operation model and may include aspects of model 342-a described with reference to FIG. 3. The second model (‘Model 2’) may include multiple models. For example, the second model (‘Model 2’) may include a maintenance model and a recovery model. The maintenance model and the recovery model may include aspects of model 342-b and model 342-c described with reference to FIG. 3, respectively.

In an example, at 620-a, the system 100 may train the first model (‘Model 1’) to estimate a resistance (e.g., total resistance (Rₜₒₜₐₗ)) of the membrane 127 for a subsequent production cycle. In some aspects, the system 100 may apply a linear regression model to estimate the resistance of the membrane 127 during the production cycle (e.g., during an operational/production mode of the membrane 127).

In an example, at 620-b, the system 100 may train the second model (‘Model 2’) to estimate a resistance (e.g., total resistance (Rₜₒₜₐₗ)) of the membrane 127 after one or more future chemical cleanings. In some aspects, the system 100 may apply a decision tree model to estimate the resistance after a chemical cleaning (e.g., a maintenance cleaning or recovery cleaning). In some aspects, estimating the resistance may include estimating a reduction in resistance of the membrane 127.

After the training of the first model (‘Model 1’) and the second model (‘Model 2’) is completed, the system 100 may save the parameters of the models to a container (e.g., a database) to use in an optimization phase at FIG. 6B.

Referring to FIG. 6B, the system 100 may implement an optimization phase to find an optimal cleaning schedule or an optimal point for chemical cleanings and also optimal concentration of chemical solutions. The optimal point may correspond to, for example, a temporal instance for cleaning the membrane 127.

The optimization phase may include use of a genetic algorithm 630. The genetic algorithm 630 is an evolutionary algorithm which inspired from natural evolution. The genetic algorithm 630, when executed, applies an iterative process in association with finding the optimal point of a predefined cost function. The cost function for the genetic algorithm 630 is calculated according to the Equation (3) below:

F(x,y)=w₁x+w₂y (3)

In Equation (3), x is the cost of energy consumption during a production cycle and cost of chemical usage, and y is a parameter related to the life span. w₁ and w₂ are predefined weights between 0 and 1, where w₂=1−w₁.

Inputs 625 to the genetic algorithm may include an initial resistance value (e.g., Rᵢₙᵢₜᵢₐₗ(n)) of the membrane 127, target volume of filtrate or target flux, time period of production, the first model (‘Model 1’), and the second model (‘Model 2’).

The genetic algorithm 630 may include a genetic algorithm parameter initialization 635, a cost calculation 640, selection of genetic algorithm operators and implementation of crossover and mutation (at 645), and a convergence check 650. The genetic algorithm 630 may generate an output 655. The output 655 may include an optimum schedule for implementing a chemical cleaning, which includes maintenance cleaning and recovery cleaning.

In an example, at 635, the genetic algorithm 630 may receive, as input data, a temporal period (e.g., 30 days of operation), an initial resistance value (e.g., Rᵢₙᵢₜᵢₐₗ(n)) of the membrane 127, and a flux set point.

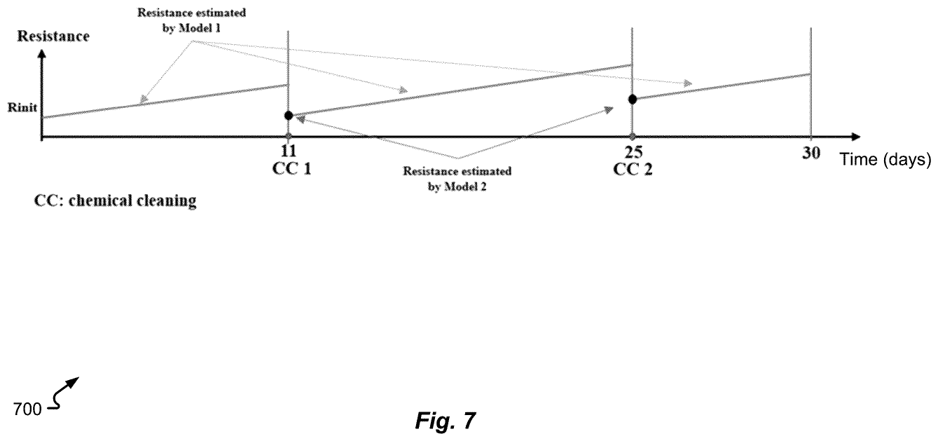

Based on the input data, the genetic algorithm 630 may generate random chemical cleaning (chemical cleaning) points included in the temporal period. An example of the temporal period (30 days) is illustrated at FIG. 7. Examples of the randomly generated maintenance cleaning points are illustrated at ‘CC 1’ (11 days) and ‘CC 2’ (25 days) of FIG. 7, where “CC” may refer to “chemical cleaning.”

At 640, using the first model (‘Model 1’) and the second model (‘Model 2’), the genetic algorithm 630 estimates a resistance of the membrane 127 at a temporal instance included in the temporal period and estimates a cost function. In an example, the genetic algorithm 630 may calculate the cost function according to a predicted cost of energy consumption and chemical consumption, and a cost of the maintenance and/or recovery cleaning in the temporal period. In some aspects, the process associated with the temporal period may be referred to as a path from a first day (e.g., day 1) to a last day (e.g., day 30) of operation. The term “path” refers to a membrane resistance record including a plurality of membrane resistance curves. Each of the plurality of membrane resistance curves includes a curve profile after a cleaning.

As described herein, aspects of the genetic algorithm 630 include creating multiple similar paths at first generation. Each path, for example, may include a prediction of the trends of resistance using the current configuration of maintenance cleanings and recovery cleaning. The genetic algorithm 630 may iteratively improve the paths by changing the temporal positions of chemical cleanings, for example, using genetic algorithm operators selected at 645. After generating each path, the genetic algorithm may improve the paths until a target criteria is achieved (e.g., a target average resistance over time, a target rate of reduction in resistance, cost of operation, a combination thereof, etc.).

FIG. 7 illustrates an example graph 700 of simulation results using the first model (‘Model 1’), the second model (‘Model 2’), and the genetic algorithm 630 as described with reference to FIG. 6.

FIG. 7 illustrates randomly generated recovery cleaning points ‘CC 1’ (11 days) and ‘CC 2’ (25 days), resistance values of the membrane 127 as estimated by the first model (‘Model 1’), and resistance values of the membrane 127 as estimated by the second model (‘Model 2’).

As described herein, aspects of the present disclosure provide techniques associated with prolonging (e.g., extending) the lifespan of a membrane 127 and preventing unnecessary cleanings (e.g., maintenance cleanings, recovery cleanings, etc.), thereby reducing operational and maintenance costs associated with cleaning and/or replacing a membrane 127 over time. For example, aspects of the present disclosure support predicting resistance of a membrane 127 and determining parameters for implementing cleanings. The parameters may include, for example, quantity of cleanings, periodicity/intervals of cleanings, chemical composition of each cleaning, threshold resistance associated with implementing a cleaning, or the like as described herein.

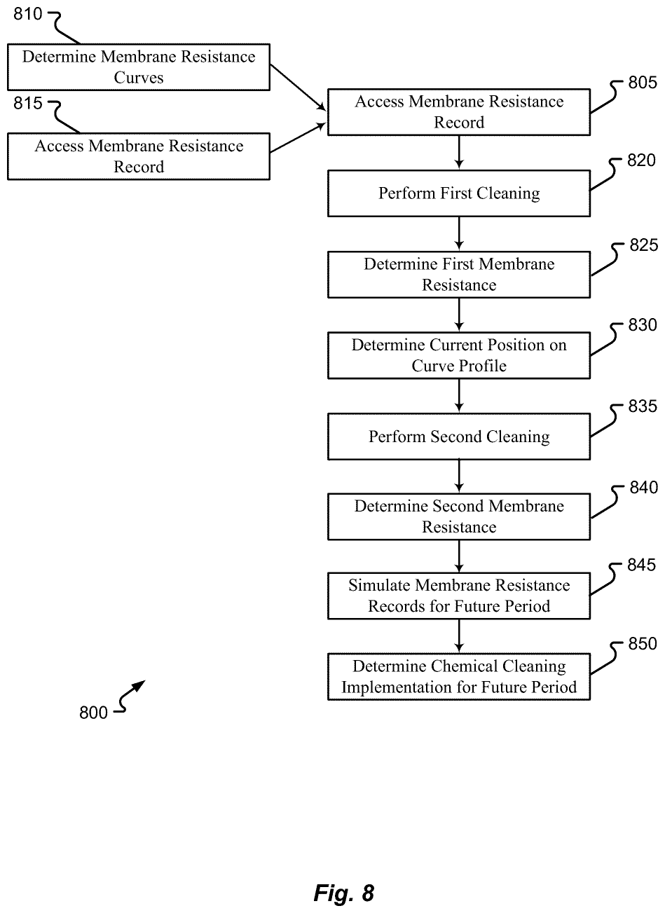

FIG. 8 illustrates a process flow 800 that supports a method of implementing membrane cleaning in accordance with aspects of the present disclosure. In some examples, the process flow 800 may implement aspects of system 100. For example, the process flow 800 may be implemented by equipment 125, a server 110 and/or a communication device 105 in association with cleaning a membrane 127 as described with reference to FIG. 1.

In the following description of the process flow 800, the operations may be performed in a different order than the order shown, or the operations may be performed in different orders or at different times. Certain operations may also be left out of the process flow 800, or other operations may be added to the process flow 800. It is to be understood that while a server 110 is described as performing a number of the operations of process flow 800, any device (e.g., another server 110, a communication device 105) may perform the operations shown.

An example of the process flow 800 is described herein with reference to FIGS. 1 and 2. The process flow 800 describes an example of applying the techniques described herein to cleaning a membrane 127 (e.g., an ultrafiltration membrane)

At 805, the process flow 800 includes accessing a membrane resistance record (e.g., resistance record 117). In some aspects, the membrane resistance record may include a plurality of membrane resistance curves. In some aspects, each of the plurality of membrane resistance curves includes a curve profile after a cleaning.

In some aspects, each of the plurality of membrane resistance curves includes information associated with membrane resistance during a membrane operation mode.

In some aspects, each of the plurality of membrane resistance curves is obtained by calculating (e.g., at 810) the membrane resistance at a flux at a predetermined time interval, and using a regression model (e.g., a linear regression model and/or a non-linear regression model) to determine (e.g., at 815) each of the plurality of membrane resistance curves.

At 820, the process flow 800 includes performing a first cleaning. In some aspects (not illustrated), the process flow 800 includes determining whether the first cleaning was performed. For example, the process flow 800 may include confirming that the first cleaning was performed.

At 825, the process flow 800 includes determining a first membrane resistance after the first cleaning. In some aspects, the first cleaning includes a maintenance cleaning or a recovery cleaning.

In some aspects, determining the first membrane resistance after the first cleaning is based on first data associated with the first cleaning. In some aspects, the first data includes information associated with least one of: a membrane resistance before the first cleaning, chemical concentrations associated with the first cleaning, flux associated with the first cleaning, total permeate volume associated with the first cleaning, and water quality parameters. For example, the first data may include flux and total permeate volume associated with the first cleaning (i.e., flux and total permeate volume during the filtration phase before the first cleaning).

In some aspects, the chemical concentrations may include a chemical concentration applied when cleaning a membrane in association with the first cleaning. In some aspects, the flux associated with the first cleaning may include a flux of the membrane before the first cleaning.

At 830, the process flow 800 includes determining a current position on the curve profile based on the first membrane resistance and a time period from a previous cleaning.

At 835, the process flow 800 includes performing a second cleaning. In some aspects, the second cleaning includes a recovery cleaning when the current position on the curve profile exceeds a predetermined range. In some aspects, the second cleaning includes a maintenance cleaning when the current position on the curve profile is within the predetermined range.

In some aspects, the predetermined range is determined based on at least one of transmembrane pressure (TMP) asserted on a membrane and flux information associated with the first cleaning.

At 840, the process flow 800 includes determining a second membrane resistance after the second cleaning based on second data associated with the second cleaning. In some aspects, the second data includes membrane resistance before the second cleaning, chemical concentrations associated with the second cleaning, flux associated with the second cleaning, and total permeate volume associated with the second cleaning. For example, the second data may include flux and total permeate volume associated with the second cleaning (i.e., flux and total permeate volume during the filtration phase before the second cleaning).

In some aspects, the chemical concentrations may include a chemical concentration applied when cleaning the membrane in association with the second cleaning. In some aspects, the flux associated with the first cleaning may include a flux of the membrane before the second cleaning.

In some aspects, each of the first membrane resistance and the second membrane resistance determined after the second cleaning includes at least one of membrane fouling resistance and membrane initial resistance.

At 845, the process flow 800 includes simulating a plurality of membrane resistance records for a predetermined future period based on the first membrane resistance, the second membrane resistance determined after the second cleaning, and the plurality of membrane resistance curves.

At 850, the process flow 800 includes determining a chemical cleaning implementation for the predetermined future period based on the plurality of membrane resistance records. In some aspects, the chemical cleaning implementation includes a chemical cleaning schedule and chemical cleaning concentrations.

In some aspects, determining the chemical cleaning implementation for the predetermined future period includes performing use optimization associated with each of the plurality of membrane resistance records; and determining the chemical cleaning implementation based on comparison of respective costs associated with the plurality of membrane resistance records.

In some aspects, performing the use optimization associated with each of the plurality of membrane resistance records is based on a set of considerations associated with the first cleaning, the second cleaning, and the chemical cleaning implementation for the predetermined future period. In some aspects, the set of considerations comprises, for each of the cleanings: a first consideration associated with energy consumption during a membrane operation mode; and a second consideration including at least one of energy consumption and chemical costs associated with a chemical cleaning concentration (e.g., both energy consumption and chemical costs associated with a chemical cleaning concentration).

The process flow 800 may support autonomous and/or semi-autonomous implementation any of the operations of the process flow 800. For example, the system 100 (e.g., via the server 110 and/or a communication device 105) may implement operator actions (e.g., cleanings, configuration of chemical cleaning implementations, etc.) with partial input from an operator or no input from an operator.

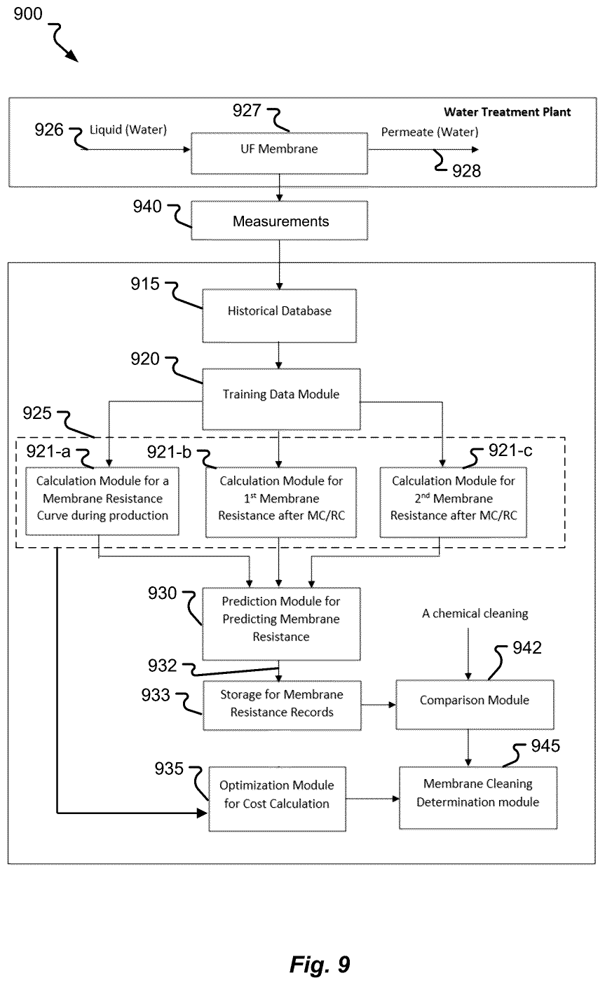

FIG. 9 illustrates an example block diagram of a system 900 that supports optimization of ultra filtration membrane performance in accordance with aspects of the present disclosure. In some examples, the system 900 may implement aspects of system 100. For example, aspects of the system 900 may be implemented by a server 110 and/or a communication device 105 described with reference to FIG. 1.

The system 900 may include a database 915 (e.g., a historical database), a training data module 920 (also referred to herein as a data preparation module), calculation modules 921, a prediction module 930, storage module 933, an optimization module 935, a comparison module 942, and a membrane cleaning determination module 945. The system 900 may include a membrane 927 and sensors (e.g., sensors 130 described with reference to FIG. 1) capable of providing measurements 940 (e.g., real-time measurements or historical measurements) (also referred to herein as sensor measurements) associated with the membrane 927. The system 900 (and components thereof) may include examples of aspects like elements described herein with reference to the system 200 of FIG. 2.

The system 900 may process measurements 940 provided by the sensors and/or store the measurements 940 to database 915. The measurements 940 are examples of the sensor measurements 240 described with reference to FIG. 2.

The training data module 920 may support features for preparing data associated with training and/or updating various models (e.g., calculation module 921-a through calculation module 921-c). The training data module 920 includes example aspects of the data preparation module 220 of FIG. 2.

The update module 925 may support features associated with training and/or updating the various models based on the data provided by the training data module 920. The update module 925 may include examples of aspects of the update module 225 of FIG. 2.

The update module 925 may include calculation modules 921. Calculation module 921-a may calculate a membrane resistance curve of a membrane 127 during a production operation/a production mode. Calculation module 921-b may calculate a first membrane resistance of the membrane 127 after a cleaning (e.g., a maintenance cleaning, a recovery cleaning). Calculation module 921-c may calculate a second membrane resistance after a subsequent cleaning (e.g., maintenance cleaning, recovery cleaning). Calculation module 921-a through calculation module 921-c may include examples of aspects of model 142-a through model 142-c (also referred to herein as “Model 1” through “Model 3”) described herein. The update module 925 may provide data (e.g., data calculated by the calculation modules 921) to the optimization module 935.

The prediction module 930 may support features of predicting a resistance 932 of the membrane 127 based on the values provided by the calculation module 921-a through calculation module 921-c. The prediction module 930 may provide the predicted resistance 932 to a storage module 933. The prediction module 930 may include examples of aspects of the prediction module 230 of FIG. 2.

The optimization module 935 may support features of exploration of multiple configurations in which maintenance cleanings and recovery cleanings are implemented. For example, the system 900 may apply the calculation module 921 and an optimization algorithm in association with determining a configuration (e.g., a “best” maintenance cleaning/recovery cleaning configuration) capable of achieving a target performance of the membrane 927, while at the same time optimizing the cost. In some aspects, the optimization algorithm may include a genetic algorithm. The optimization module 935 may include examples of aspects of the optimization module 235 of FIG. 2.

The comparison module 942 may compare the predicted resistance 932 of the membrane 127 against a curve profile obtained from the storage module 933. The comparison module 942 may provide data indicating a result of the comparison to the membrane cleaning determination module 945.

Based on the result of the comparison, the membrane cleaning determination module 945 may determine whether to perform a cleaning (e.g., a maintenance cleaning or a recovery cleaning) as described herein.

Any of the steps, functions, and operations discussed herein can be performed continuously and automatically.

The exemplary systems and methods of this disclosure have been described in relation to examples of a server 110, a communication device 105, equipment 125, a membrane 127, and sensor devices 130. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a communications network and/or the Internet, or within a dedicated secure, unsecured and/or encrypted system. Thus, it should be appreciated, that the components of the system can be combined into one or more devices, such as a server, communication device, or collocated on a particular node/element(s) of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. Furthermore, it should be appreciated that the various communications links, including communications channel(s), connecting the elements can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the embodiment(s). Additionally, the exact sequence of events need not occur as set forth in the disclosed embodiments, but rather the steps can be performed by one or the other device(s) in the system. Additionally, the exemplary techniques illustrated herein are not limited to the specifically illustrated embodiments but can also be utilized with the other exemplary embodiments and each described feature is individually and separately claimable. As will be appreciated by one skilled in the art, aspects of the present disclosure may be embodied as a system, method, and/or computer program product. Thus, aspects of the present disclosure may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

A computer readable medium as described herein may be a computer readable storage medium, examples of which include, but are not limited to, an electronic, magnetic, optical, electromagnetic, infrared, or semiconductor system, apparatus, or device, or any suitable combination thereof. As used herein, a computer readable storage medium may be any non-transitory, tangible medium that can contain or store a program for use by or in connection with an instruction execution system, apparatus, device, computer, computing system, computer system, or any programmable machine or device that inputs, processes, and outputs instructions, commands, or data. A non-exhaustive list of specific examples of a computer readable storage medium include an electrical connection having one or more wires, a portable computer diskette, a floppy disk, a hard disk, a random access memory (RAM), a read-only memory (ROM), a USB flash drive, an non-volatile RAM (NVRAM or NOVRAM), an erasable programmable read-only memory (EPROM or Flash memory), a flash memory card, an electrically erasable programmable read-only memory (EEPROM), an optical fiber, a portable compact disc read-only memory (CD-ROM), a DVD-ROM, an optical storage device, a magnetic storage device, or any suitable combination thereof. A computer readable storage medium can be any computer readable medium that is not a computer readable signal medium such as a propagated data signal with computer readable program code embodied therein.

Program code may be embodied as computer-readable instructions stored on or in a computer readable storage medium as, for example, source code, object code, interpretive code, executable code, or combinations thereof. Any standard or proprietary, programming or interpretive language can be used to produce the computer-executable instructions. Examples of such languages include C, C++, C#, Pascal, JAVA, JAVA Script, BASIC, Smalltalk, Visual Basic, and Visual C++.

Transmission of program code embodied on a computer readable medium can occur using any appropriate medium including, but not limited to, wireless, wired, optical fiber cable, radio frequency (RF), or any suitable combination thereof.

The program code may execute entirely on a user's/operator's/administrator's computer, partly on such a computer, as a stand-alone software package, partly on the user's/operator's/administrator's computer and partly on a remote computer, or entirely on a remote computer or server. Any such remote computer may be connected to the user's/operator's/administrator's computer through any type of network, including a local area network (LAN) or a wide area network (WAN), or the connection may be made to an external computer (for example, through the Internet using an Internet Service Provider).

A number of variations and modifications of the disclosure can be used. It would be possible to provide for some features of the disclosure without providing others.

In yet another embodiment, the systems, methods and protocols described herein can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various communication methods, protocols and techniques according to the aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein include, but are not limited to, at least one of Qualcomm® Snapdragon® 800 and 801, Qualcomm® Snapdragon® 610 and 615 with 4G LTE Integration and 64-bit computing, Apple® A7, A8, A8X, A9, A9X, or A10 processors with 64-bit architecture, Apple® M7, M8, M9, or M10 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer, workstation or mobile device platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized. The methods illustrated herein however can be readily implemented in hardware and/or software using any known or later developed systems or structures, devices and/or software by those of ordinary skill in the applicable art from the functional description provided herein and with a general basic knowledge of the computer and image processing arts.

In yet another embodiment, the disclosed methods may be partially implemented in software that can be stored on a storage medium, executed on programmed general-purpose computer with the cooperation of a controller and memory, a special purpose computer, mobile device, smartphone, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, as a plug-in, a system component, or the like. The system can also be implemented by physically incorporating the system and/or method into a software and/or hardware system, such as the hardware and software systems of an image processor.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

The terms “determine,” “calculate,” “compute,” and variations thereof, as used herein, are used interchangeably and include any type of methodology, process, mathematical operation or technique.

While this technology has been described in conjunction with a number of embodiments, it is evident that many alternatives, modifications and variations would be or are apparent to those of ordinary skill in the applicable arts. Accordingly, it is intended to embrace all such alternatives, modifications, equivalents, and variations that are within the spirit and scope of this disclosure.

All references mentioned in the document submitted herewith are herein incorporated by reference in their entirety.

1. A method of implementing membrane cleaning, the method comprising:
accessing a membrane resistance record, wherein the membrane resistance record comprises a plurality of membrane resistance curves that form a curve profile that predicts membrane resistance of a membrane during a membrane operation mode, after a maintenance cleaning, and after a recovery cleaning based on computer models trained with data associated with the membrane operation mode, the maintenance cleaning, and the recovery cleaning;
performing, by equipment, a first cleaning of the membrane;
generating, by at least one sensor, sensor data indicative of a first membrane resistance of the membrane after the first cleaning;
determining, based on the sensor data from the at least one sensor, the first membrane resistance;
determining a current position on the curve profile based on the first membrane resistance; and
performing, by the equipment, a second cleaning of the membrane, wherein the second cleaning includes a recovery cleaning of the membrane when the current position on the curve profile exceeds a predetermined membrane resistance range, and a maintenance cleaning of the membrane when the current position on the curve profile is within the predetermined membrane resistance range.

2. The method of claim 1, wherein determining the first membrane resistance after the first cleaning is based on first data associated with the first cleaning, wherein the first data includes information associated with at least one of: a membrane resistance of the membrane before the first cleaning, chemical concentrations associated with the first cleaning, flux associated with the first cleaning, and total permeate volume associated with the first cleaning.

3. The method of claim 1, wherein the predetermined membrane resistance range is determined based on at least one of transmembrane pressure (TMP) asserted on a membrane and flux information associated with the first cleaning.

4. The method of claim 1, further comprising determining a second membrane resistance of the membrane after the second cleaning based on second data associated with the second cleaning, wherein the second data includes membrane resistance of the membrane before the second cleaning, chemical concentrations associated with the second cleaning, flux associated with the second cleaning, and total permeate volume associated with the second cleaning.

5. The method of claim 1, further comprising:
training the computer models with the data associated with the membrane operation mode, the maintenance cleaning, and the recovery cleaning; and
generating the membrane resistance record based on the trained computer models.

6. The method of claim 1, wherein each of the plurality of membrane resistance curves is obtained by calculating membrane resistance of the membrane at a flux at a predetermined time interval, and by using a regression model.

7. The method of claim 1, further comprising simulating a plurality of membrane resistance records for a predetermined future period based on the first membrane resistance, a second membrane resistance of the membrane determined after the second cleaning, and the plurality of membrane resistance curves.

8. The method of claim 7, further comprising determining a chemical cleaning implementation for the predetermined future period based on the plurality of membrane resistance records, wherein the chemical cleaning implementation includes a chemical cleaning schedule and chemical cleaning concentrations.

9. The method of claim 8, wherein determining the chemical cleaning implementation for the predetermined future period includes:
performing use optimization associated with each of the plurality of membrane resistance records; and
determining the chemical cleaning implementation based on comparison of a cost associated with each of the plurality of membrane resistance records.

10. The method of claim 9, wherein performing the use optimization associated with each of the plurality of membrane resistance records is based on a set of considerations associated with the first cleaning, the second cleaning, and the chemical cleaning implementation for the predetermined future period, wherein the set of considerations comprises, for each of the cleanings:
a first consideration associated with energy consumption during the membrane operation mode; and
a second consideration including at least one of energy consumption and chemical costs associated with a chemical cleaning concentration.

11. The method of claim 1, wherein the first cleaning includes a maintenance cleaning or a recovery cleaning.

12. The method of claim 1, wherein each of the first membrane resistance and a second membrane resistance of the membrane determined after the second cleaning includes at least one of a membrane fouling resistance and a membrane initial resistance.

13. A device comprising:
a processor; and
a memory coupled with the processor, wherein the memory stores instructions that, when executed by the processor, enables the processor to:
access a membrane resistance record, wherein the membrane resistance record comprises a plurality of membrane resistance curves that form a curve profile that predicts membrane resistance of a membrane during a membrane operation mode, after a maintenance cleaning, and after a recovery cleaning based on computer models trained with data associated with the membrane operation mode, the maintenance cleaning, and the recovery cleaning;
send a control signal to equipment that instructs the equipment to perform a first cleaning, wherein the first cleaning includes a maintenance cleaning or a recovery cleaning;
receive, from at least one sensor over a communication network, sensor data indicative of a first membrane resistance of the first membrane after the first cleaning; determine, based on the received sensor data, the first membrane resistance;
determine a current position on the curve profile based on the first membrane resistance; and
send a control signal to the equipment that instructs the equipment to perform a second cleaning, wherein the second cleaning includes:
a recovery cleaning when the current position on the curve profile exceeds a predetermined membrane resistance range; and
a maintenance cleaning when the current position on the curve profile is within the predetermined membrane resistance range.

14. The device of claim 13, wherein determining the first membrane resistance after the first cleaning is based on first data associated with the first cleaning, wherein the first data includes information associated with at least one oft a membrane resistance of the membrane before the first cleaning, chemical concentrations, flux associated with the first cleaning, and total permeate volume associated with the first cleaning.

15. The device of claim 13, wherein the predetermined membrane resistance range is determined based on at least one of transmembrane pressure (TMP) asserted on a membrane and flux information associated with the first cleaning.

16. The device of claim 13, wherein the instructions are further executable by the processor to determine a second membrane resistance of the membrane after the second cleaning based on second data associated with the second cleaning, wherein the second data includes membrane resistance of the membrane before the second cleaning, chemical concentrations associated with the second cleaning, flux associated with the second cleaning, and total permeate volume associated with the second cleaning.

17. The device of claim 13, wherein the instructions are further executable by the processor to:
train the computer models with the data associated with the membrane operation mode, the maintenance cleaning, and the recovery cleaning; and
generate the membrane resistance record based on the trained computer models.

18. The device of claim 13, wherein each of the plurality of membrane resistance curves is obtained by calculating the membrane resistance at a flux at a predetermined time interval, and using a regression model to determine each of the plurality of membrane resistance curves.

19. The device of claim 13, wherein the instructions are further executable by the processor to simulate a plurality of membrane resistance records for a predetermined future period based on the first membrane resistance, a second membrane resistance of the membrane determined after the second cleaning, and the plurality of membrane resistance curves.

20. A system comprising:
a processor; and
a memory coupled with the processor, wherein the memory stores instructions that, when executed by the processor, enables the processor to:
access a membrane resistance record, wherein the membrane resistance record comprises a plurality of membrane resistance curves that form a curve profile that predicts membrane resistance of a membrane during a membrane operation mode, after a maintenance cleaning, and after a recovery cleaning based on computer models trained with data associated with the membrane operation mode, the maintenance cleaning, and the recovery cleaning;
send a control signal to equipment that instructs the equipment to perform a first cleaning;
receive, from at least one sensor over a communication network, sensor data indicative of a first membrane resistance of the first membrane after the first cleaning;
determine, based on the sensor data, the first membrane resistance of the membrane;
determine a current position on the curve profile based on the first membrane resistance; and
send a control signal to the equipment that instructs the equipment to perform a second cleaning, wherein the second cleaning includes:
a recovery cleaning when the current position on the curve profile exceeds a predetermined membrane resistance range; and
a maintenance cleaning when the current position on the curve profile is within the predetermined membrane resistance range,
wherein each of the first membrane resistance and a second membrane resistance of the membrane determined after the second cleaning includes at least one of a membrane fouling resistance and a membrane initial resistance.
